(19) United States
(12) Patent Application Publication
(10) Pub. No.: US 2026/0261373 A1
(43) Pub. Date: Sep. 3, 2026

(54) METHODS AND APPARATUSES FOR SBFD OPERATION

(71) Applicant: SHENZHEN TCL NEW TECHNOLOGY CO., LTD., Shenzhen, Guangdong (CN)

(72) Inventor: Shahid JAN, Shenzhen, Guangdong (CN)

(73) Assignee: SHENZHEN TCL NEW TECHNOLOGY CO., LTD., Shenzhen, Guangdong (CN)

(21) Appl. No.: 18/872,789

(22) PCT Filed: Jun. 24, 2022
(86) PCT No.: PCT/CN2022/101065

§ 371 Date: Dec. 6, 2024

(51) Int. Cl. H04L 5/00; H04L 5/14; H04L 27/26

(52) U.S. Cl. CPC H04L 5/0044; H04L 27/2656; H04L 5/14

(57) ABSTRACT

Methods and apparatuses for sub-band full duplex (SBFD) operation are disclosed. The method performed by a base station includes performing, by the base station, an SBFD operation using a configuration of the SBFD operation or an indication to the user equipment (UE), wherein the configuration of the SBFD operation includes an uplink (UL) sub-band in downlink (DL), or flexible slots/symbols or DL sub-band in UL, or flexible slots/symbols along with UL/DL sub-band configurable parameters, and/or a management of a co-existence of an SBFD capable UE and a legacy UE.

### BACKGROUND OF DISCLOSURE

### 1. Field of the Disclosure

The present disclosure relates to the field of wireless communication systems, and more particularly, to methods and apparatuses for sub-band full duplex (SBFD) operation, for example, SBFD operation in 5G new radio (NR) communication systems. More specifically, the present disclosure discusses necessary requirements and features of sub-bands, a sub-band configuration/indication to a UE, and methods of handling a co-existence of a legacy UE and an SBFD capable UE in a cell.

### 2. Description of the Related Art

In conventional time division duplex (TDD) systems, time domain resources are split between downlink (DL) symbols, uplink (UL) symbols, and flexible symbols, where the flexible symbols can be used as DL, UL, or a guard period for DL-UL switching. Allocation of a limited time duration for uplink in the conventional TDD systems would result in reduced coverage, increased latency, and reduced capacity.

Most of companies support sub-band non-overlapping full duplex operation. In addition, there are many proposals which support how to perform UL transmission in DL slots or DL transmission in UL slot. However, there is no clear proposal to explain how to design and allocate physical layer resources for sub-bands, and how to indicate the sub-bands to a UE.

### SUMMARY

An object of the present disclosure is to propose methods and apparatuses for sub-band full duplex (SBFD) operation.

In a first aspect of the present disclosure, a method for sub-band full duplex (SBFD) operation performed by a base station includes performing, by the base station, an SBFD operation using a configuration of the SBFD operation or an indication to the user equipment (UE), wherein the configuration of the SBFD operation includes an uplink (UL) sub-band in downlink (DL), or flexible slots/symbols or DL sub-band in UL, or flexible slots/symbols along with UL/DL sub-band configurable parameters, and/or a management of a co-existence of an SBFD capable UE and a legacy UE.

In a second aspect of the present disclosure, a base station comprises a memory, a transceiver, and a processor coupled to the memory and the transceiver. The processor is configured to perform the above method.

In a third aspect of the present disclosure, a non-transitory machine-readable storage medium has stored thereon instructions that, when executed by a computer, cause the computer to perform the above method.

In a fourth aspect of the present disclosure, a chip includes a processor, configured to call and run a computer program stored in a memory, to cause a device in which the chip is installed to execute the above method.

In a fifth aspect of the present disclosure, a computer readable storage medium, in which a computer program is stored, causes a computer to execute the above method.

In a sixth aspect of the present disclosure, a computer program product includes a computer program, and the computer program causes a computer to execute the above method.

In a seventh aspect of the present disclosure, a computer program causes a computer to execute the above method.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a block diagram of one or more user equipments (UEs) and a base station (e.g., gNB) of communication in a communication network system according to an embodiment of the present disclosure.

FIG. 2 is a flowchart illustrating a method for sub-band full duplex (SBFD) operation performed by a base station according to an embodiment of the present disclosure.

FIG. 3 is a schematic diagram illustrating an example of UL sub-band in inner RBs of DL slots/symbols according to an embodiment of the present disclosure.

FIG. 4 is a schematic diagram illustrating an example of UL sub-bands in edge RBs or higher carriers of DL slots/symbols according to an embodiment of the present disclosure.

FIG. 5 is a schematic diagram illustrating an example of UL sub-bands in edge RBs or lower carriers of the DL slots/symbols according to an embodiment of the present disclosure.

FIG. 6 is a schematic diagram illustrating an example of two sub-band configuration with UL sub-bands in a higher carrier of DL slots/symbols according to an embodiment of the present disclosure.

FIG. 7 is a schematic diagram illustrating an example of two sub-band configuration with UL sub-bands in a lower carrier of DL slots/symbols according to an embodiment of the present disclosure.

FIG. 8 is a schematic diagram illustrating an example of DL sub-band in inner RBs of UL slots/symbols according to an embodiment of the present disclosure.

FIG. 9 is a schematic diagram illustrating an example of DL sub-band in edge RBs or lower carriers of UL slots/symbols according to an embodiment of the present disclosure.

FIG. 10 is a schematic diagram illustrating an example of DL sub-band in edge RBs or higher carriers of UL slots/symbols according to an embodiment of the present disclosure.

FIG. 11 is a schematic diagram illustrating an example of two sub-band configuration with DL sub-bands in a lower carrier of UL slots/symbols according to an embodiment of the present disclosure.

FIG. 12 is a schematic diagram illustrating an example of two sub-band configuration with DL sub-bands in a higher carrier of UL slots/symbols according to an embodiment of the present disclosure.

FIG. 13 is a schematic diagram illustrating an example of SFI transmission in nth DL slot/symbol according to an embodiment of the present disclosure.

FIG. 14 is a schematic diagram illustrating an example of gNB side's resource allocation to UL and DL sub-bands according to an embodiment of the present disclosure.

FIG. 15 is a schematic diagram illustrating an example of UL-DL sub-bands frequency resource visibility to an SBFD capable UE according to an embodiment of the present disclosure.

FIG. 16 is a schematic diagram illustrating an example of UL-DL slot visibility to an SBFD capable UE according to an embodiment of the present disclosure.

FIG. 17 is a schematic diagram illustrating an example of UL-DL sub-band frequency resource visibility to a legacy UE according to an embodiment of the present disclosure.

FIG. 18 is a schematic diagram illustrating an example of UL-DL slot visibility to a legacy UE according to an embodiment of the present disclosure.

FIG. 19 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

The diversified use cases and exponential growth of number of UEs in the next generation wireless communication system have increased the data traffic explosively which leads to the high requirements of spectral efficiency. In order to accomplish the requirements of high spectral efficiency, time division duplex TDD system is widely adopted in commercial NR deployments. TDD system uses a single spectrum (frequency band) for downlink (DL) and uplink (UL) in different time slots, and utilizes the available spectrum more efficiently as compared to a frequency division duplex (FDD) system.

In order to enhance the limitations of conventional TDD operation, 3GPP RAN working group approves a study item [1] in Rel-18, which focus on the feasibility of simultaneous existence of DL and UL, as known as full duplex, or more specifically, sub-band non-overlapping full duplex operation within a conventional TDD band. In SBFD operation, gNB is operated in full duplex, i.e., the simultaneous DL and UL transmission occurs at gNB side only while the UE operates in half duplex. The study item specifies the following RAN1 objectives regarding the sub-band non-overlapping full duplex and dynamic/flexible TDD operation: Study the sub-band non-overlapping full duplex and potential enhancements on dynamic/flexible TDD (RAN1, RAN4). In Rel-18 SID for duplex evolution it is mentioned, to study the sub-bands non overlapping full duplex operation and identify possible schemes to evaluate its feasibility and performance. In addition, the following agreements are achieved in 3GPP RAN1 #109-e meeting, which considers SBFD operation within a conventional TDD band and focus on further enhancement of resources allocation for sub-bands at gNB side and its indication to the UE: 1. Study the impact/potential enhancements of resource allocation in symbols with sub-bands that gNB would use for SBFD operation. 2. Study whether/how to inform the UE of the time and/or frequency location of sub-bands that gNB would use for SBFD operation.

Comparing the features of conventional TDD operation with sub-band full (SBFD), the key objective of SBFD is to allow simultaneous DL and UL transmission in a TDD carrier. However, the detail design of sub-bands and its use for full duplex operation is still under discussion and there are no comprehensive proposals which can clarify the detail design of a sub-band for full duplex operation. In addition, there is also a discussion regarding the important features of SBFD, such as the number of sub-bands in a conventional TDD band, the granularity of a sub-band, and the time/frequency resources allocation to a sub-band. For the reasons, this disclosure further studies the detail design of sub-bands in a conventional TDD band with focus on the necessary requirements or feature of a sub-band (i.e., granularity, number of sub-bands, bandwidth, etc.), time/frequency resources allocation, configuration/indication of sub-bands to the UE, and co-existence of SBFD capable UE with the legacy UE in a cell.

Sub-band non-overlapping full duplex improves the UL coverage, reduces the latency, and increase the capacity. However, SBFD operation is a new feature defined in Rel-18 and its physicals layer design face the following challenges. 1. How to allocate physical resources to a sub-band, e.g., which time/frequency resources of a conventional TDD band can be allocated to sub-band. 2. What shall be the granularity, and bandwidth of time/frequency location of a sub-band within a TDD band. 3. How to configure/Indicate the time/frequency resources to a UE. 4. How to manage the co-existence of SBFD capable UE and legacy UE in a cell.

Some embodiments of the present disclosure propose the basic requirements and features of a sub-band and its configurable parameters in order to fully utilize the flexibility of SBFD operation, and increase the UL coverage, reduce the transmission latency, and increase the system capacity. The proposed solutions to achieve our objectives are summarized as below. 1. Several configurable parameters of sub-bands are defined such as configurable granularity, bandwidth, time/frequency resource allocation etc. 2. Both Semi-static and dynamic configuration of SBFD is considered to inform the physical resources of sub-bands to the UE explicitly. 3. Several co-existence options of SBFD capable UE and legacy UE in a cell is proposed.

Some embodiments of the present disclosure propose several configurable parameters of sub-bands and have the following advantages: 1. Some embodiments of the present disclosure support full duplex operation (i.e., simultaneous UL/DL transmission) at gNB side to enhance the UL coverage, reduce the transmission latency, and increase the system capacity. 2. The proposed solutions present configurable parameters of sub-band to fully utilize the flexibility of sub-band full duplex operation and define sub-bands according to the UL/DL traffic requirements. 3. The proposed solutions consider the co-existence of legacy UE and SBFD capable UE in order to improve the backward compatibility.

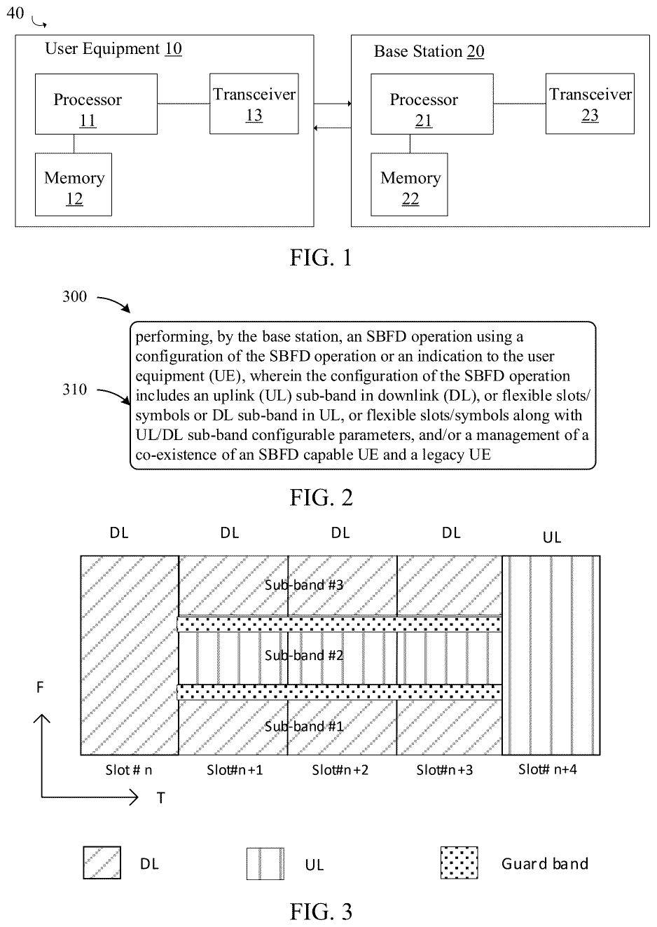

FIG. 1 illustrates that, in some embodiments, one or more user equipments (UEs) 10 and a base station (e.g., gNB) 20 (or can be called a network) for communication in a communication network system 40 according to an embodiment of the present disclosure are provided. The communication network system 40 includes the one or more UEs 10 and the base station 20. The one or more UEs 10 may include a memory 12, a transceiver 13, and a processor 11 coupled to the memory 12 and the transceiver 13. The base station 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

In some embodiments, the processor 21 is configured to perform an SBFD operation using a configuration of the SBFD operation or an indication to the user equipment (UE), wherein the configuration of the SBFD operation includes an uplink (UL) sub-band in downlink (DL), or flexible slots/symbols or DL sub-band in UL, or flexible slots/symbols along with UL/DL sub-band configurable parameters, and/or a management of a co-existence of an SBFD capable UE and a legacy UE.

FIG. 2 is a flowchart illustrating a method 300 for sub-band full duplex (SBFD) operation performed by a base station according to an embodiment of the present disclosure. In some embodiments, the method 300 for multi-TRP transmission performed by the base station includes: a step 310, performing, by the base station, an SBFD operation using a configuration of the SBFD operation or an indication to the user equipment (UE), wherein the configuration of the SBFD operation includes an uplink (UL) sub-band in downlink (DL), or flexible slots/symbols or DL sub-band in UL, or flexible slots/symbols along with UL/DL sub-band configurable parameters, and/or a management of a co-existence of an SBFD capable UE and a legacy UE.

In some embodiments, the UL/DL sub-band configurable parameters comprise sub-band features and/or an allocation of time/frequency resources to UL/DL sub-bands. In some embodiments, the sub-band features comprise a granularity of a sub-band, a bandwidth of the sub-band, and/or a number of sub-bands in a time division duplex (TDD) band. In some embodiments, the granularity of a sub-band is a resource block (RB) based granularity. In some embodiments, a number of RBs for the sub-band depends on a sub-carrier spacing of different numerology, and/or the number of RBs for the sub-band is configurable, which is adjusted according to bandwidth requirements of the sub-band. In some embodiments, the bandwidth of the sub-band is a configurable bandwidth of the sub-band, and a function to calculate the bandwidth of the sub-band is as follows:

$$SubBand ( BW ) = [ \frac{[ TDD Channel BW - ( k \times GB ( bandwid𝔱h ) ) ]}{n} ] ,$$

where TDD Channel BW is a new radio (NR) TDD band channel bandwidth in which the sub-bands are configured, K is a number of guard bands, GB (bandwidth) represents a bandwidth of the guard bands defined for the sub-bands, and n is a total number of the sub-bands in conventional TDD bands and n ranges in {2, 3, 4}.

In some embodiments, in the number of the sub-bands in the TDD band, a minimum number of the sub-bands in the TDD band is 2, and/or a maximum number of the sub-bands in the TDD band is 3 or 4. In some embodiments, the allocation of the time/frequency resources to the UL/DL sub-bands comprises a time/frequency location of UL sub-bands in DL slots/symbols and/or a time/frequency location of DL sub-bands in UL slots/symbols. In some embodiments, for the time/frequency location of the UL sub-bands in the DL slots/symbols, the UL sub-bands are allocated in DL slots starting from DL slot (n+1), where the base station is allowed to use a nth slot for control related functions of dynamic changing through a slot format indication (SFI) carrying by downlink control information (DCI) format 2_0 with cyclic redundancy check (CRC) scrambled by SFI-radio network temporary identifier (SFI-RNTI). In some embodiments, a frequency location of an UL sub-band in the DL slots/symbols is allocated in an inner part of carriers or inner RBs between two DL sub-bands.

In some embodiments, a frequency location of an UL sub-band in the DL slots/symbols is allocated in edge RBs or an outer carrier of the TDD band. In some embodiments, for a time location of a DL sub-band in UL slots, DL sub-bands are allocated in the UL slots/symbols starting from a nth UL slot. In some embodiments, a frequency location of the DL sub-band in the UL slots/symbols is allocated in an inner part of carriers or inner RBs between two UL sub-bands. In some embodiments, a frequency location of the DL sub-band in the UL slots/symbols is allocated edge RBs or an outer carrier of the TDD band. In some embodiments, the SBFD configuration and indication to the UE comprises a semi-static and dynamic configuration/indication of the sub-band to the UE, for simultaneous UL and DL transmission at the base station and half duplex operation at the UE. In some embodiments, for a semi-static configuration/indication of the SBFD operation, a semi-static configuration RRC signaling is used to configure the UL sub-bands in DL slots/symbols or DL sub-bands in UL slots/symbols.

In some embodiments, the semi-static configuration RRC signaling comprises TDD-UL-DL-ConfigCommon or TDD-UL-DL-ConfigDedicated, where the TDD-UL-DL-ConfigCommon determines a cell specific UL/DL TDD configuration, and the TDD-UL-DL-ConfigDedicated determines a UE-specific UL/DL TDD configuration. In some embodiments, information elements (IEs) for the UL sub-band in the DL slots/symbols are used to indicate an explicit configuration of SCS, the DL slots/symbols where the frequency resources of UL sub-bands are allocated in the DL slots/symbols, the RBs of the guard band, and/or the number and starting of UL RBs. In some embodiments, information elements (IEs) for the DL sub-band in the UL slots/symbols are used to indicate an explicit configuration of SCS, the UL slots/symbols where the frequency resources of DL sub-bands are allocated in the UL slots/symbols, the RBs of the guard band, and/or the number and starting of DL RBs.

In some embodiments, for a dynamic configuration/indication of the SBFD operation, the SFI for UL sub-bands in the DL slots comprises the following fields comprising a number of DL slots, a number of DL symbols, a starting of DL slot, a starting of UL PRB, a number of UL PRB, and a guard band. In some embodiments, for the dynamic configuration/indication of the SBFD operation, the SFI for DL sub-bands in the UL slots comprises the following fields comprising a number of UL slots, a number of UL symbols, a starting of UL slot, a starting of DL PRB, a number of DL PRB, and a guard band. In some embodiments, for dynamic indication of the UL sub-band in the DL slots/symbols, the SFI is transmitted in a nth DL slot/symbol, where slots n, n+1, and n+2 are configured as DL slots. In some embodiments, performing, by the base station, the management of the co-existence of the SBFD capable UE and the legacy UE in the cell comprises of configuring/indicating an SBFD operation to the SBFD capable UE and a conventional TDD operation to the legacy UE in the cell via cell specific configuration/indication comprising TDD-UL-DL-ConfigCommon, UE specific configuration comprising TDD-UL-DL-ConfigDedicated, or a dynamic SFI based configuration/indication.

In some embodiments, the method further comprises configuring/indicating the legacy UE and the SBFD capable UE via TDD-UL-DL-ConfigCommon by including the SBFD IE of UL/DL sub-bands in DL/UL slots/symbols, wherein the SBFD IE of UL/DL sub-bands in DL/UL slots/symbols is not visible to the legacy UE. In some embodiments, the method further comprises configuring/indicating the legacy UE via TDD-UL-DL-ConfigCommon and the SBFD capable UE via TDD-UL-DL-ConfigDedicated by including the SBFD IE of UL/DL sub-bands in DL/UL slots/symbols. In some embodiments, the method further comprises configuring/indicating the legacy UE through TDD-UL-DL-ConfigCommon and the SBFD capable UE via a dynamic SFI. In some embodiments, the method further comprises configuring/indicating the legacy UE through TDD-UL-DL-ConfigDedicated and SBFD capable UE via dynamic SFI.

Some embodiments of the present disclosure consider sub-band full duplex on gNB side and discuss the detail design, physical layer resources allocation and configuration of SBFD operation. Some embodiments discuss the sub-bands requirements such as granularity, bandwidth, number of sub-bands, and time/frequency resources allocation to the sub-bands. Some embodiments discuss the semi-static and dynamic configuration of a sub-bands. Some embodiments discuss the co-existence of SBFD capable and legacy capable UE.

A sub-band is a set of consecutive resource block (RBs) for the same transmission direction i.e., UL or DL direction in a resource grid of a conventional TDD band as discussed in 3GPP RAN1 #109-e meeting. Some embodiments of the present disclosure discuss basic parameters or features of a sub-band including granularity, bandwidth of a sub-band, number of sub-bands in TDD band, etc. as given below.

Granularity: Granularity is a key feature to define for a sub-band which can further clarify the frequency resources assigned to a sub-band. The physical resources in frequency domain defined by the current specification are resources elements (RE), resource block (RB), and bandwidth part (BWP) etc. However, some embodiments of this disclosure consider RB as the granularity of a sub-band. The RB based granularity has the advantaged that multiple RB sets can be configured for a UE according to the UL/DL sub-bands bandwidth requirements, and it can improve the flexibility of gNB scheduling. In addition, the number of RBs for a sub-band depends on the sub-carrier spacing of different numerology as given in [38.211], and the number of RBs for a sub-band can be considered as a configurable parameter, which can be adjusted according to the actual bandwidth requirements of a sub-band.

Bandwidth of a sub-band: The bandwidth of a sub-band depends on several physical resources parameters of the current NR specification, such as the channel bandwidth of a TDD band for each sub carrier spacing (SCS) in which sub-bands are defined, number of sub-bands in a TDD band, bandwidth of Guard bands defines for a sub-band, and the number of guard bands. This disclosure defines a configurable bandwidth for a sub-band and define a function to calculate the bandwidth of a sub-band as given below

$$SubBand ( BW ) = [ \frac{[ TDD Channel BW - ( k \times GB ( bandwid𝔱h ) ) ]}{n} ] ,$$

where TDD Channel BW is a new radio (NR) TDD band channel bandwidth in which the sub-bands are configured, K is a number of guard bands, GB (bandwidth) represents a bandwidth of the guard bands defined for the sub-bands, and n is a total number of the sub-bands in conventional TDD bands and n ranges in {2, 3, 4}. That is, the bandwidth of the sub-band is a configurable bandwidth of the sub-band, and the function to calculate the bandwidth of sub-band depend on: the new radio (NR) TDD band channel bandwidth in which the sub-bands are configured, the number of guard bands, the bandwidth of the guard bands defined for the sub-bands, and the total number of the sub-bands in conventional TDD bands in range of {2, 3, 4}.

Number of sub-bands in TDD band: Sub-band can be allocated as UL sub-band in DL or flexible slots, or DL sub-bands in UL or flexible slots. In order to define a configurable number of sub-bands in a TDD band, it is necessary to consider the minimum and maximum range of number of sub-bands in a TDD band. For minimum sub-bands it is a matter of common understanding that at-least 2 sub-bands are necessary to define, where one of the sub-bands in DL, UL or flexible slot can be consider in opposite transmission direction. For maximum number of a sub-band, some embodiments of this disclosure consider limiting the maximum number to 3 or 4 sub-bands in TDD band.

Some embodiments of the present disclosure discuss the time/frequency location of UL sub-bands in DL or flexible slots/symbols. For time location of an UL sub-band in DL slots/symbols this disclosure proposes to allocate UL sub-bands in DL slots starting from DL slot (n+1). The n+1 slot allocation will allow gNB to use the nth slot for control related functions of dynamic changing in sub-bands allocation through slot format indication (SFI) carrying by DCI format 2_0 with CRC scrambled by SFI-RNTI. For the frequency location of a sub-band in a conventional TDD band, there are two options as given below.

Option 1: The frequency location of an UL sub-band in DL slots/symbols can be allocated in the inner part of carriers or the inner RBs between the two DL sub-bands. For instance, consider three sub-bands in a TDD conventional band in which sub-band #2 can be used as UL sub-band in between sub-band #1 and sub-band #3 as shown in FIG. 3. Option 1 has the advantage to avoid the CLI from the adjacent gNBs which are using the same TDD bands in different direction. However, in option 1, at least three sub-bands and two guard bands are necessary to define in order to allocate the inner sub-band for UL direction and avoid the power leakage of Tx/Rx from the opposite direction sub-bands respectively, as shown in FIG. 3. Thus, option 1 increases the configuration overhead and waste the frequency resources.

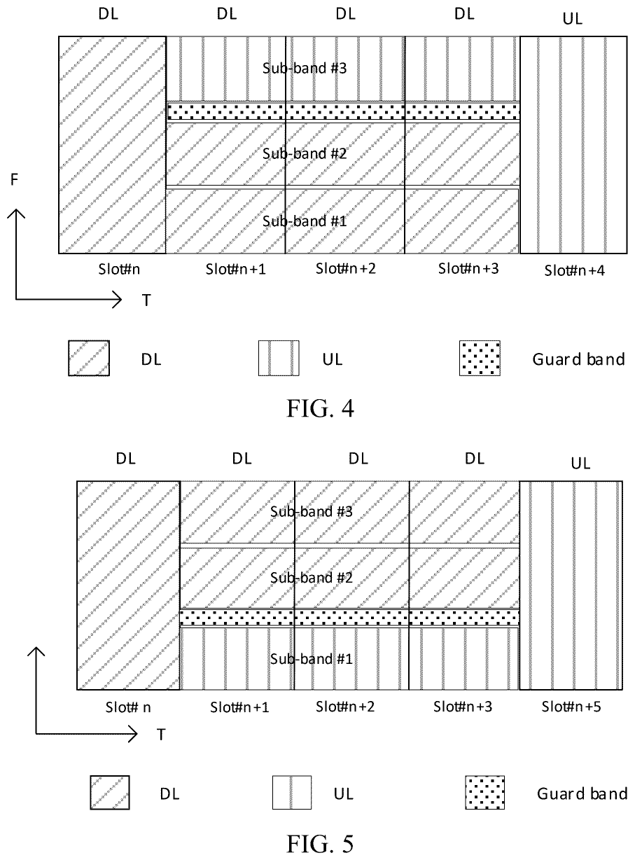

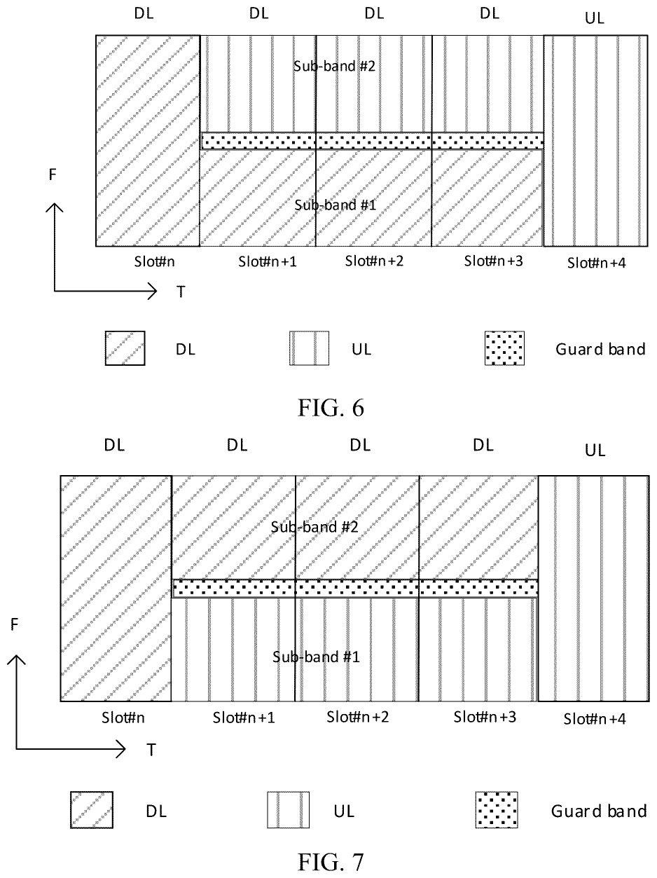

Option 2: The frequency location of an UL sub-band in DL slots/symbols can be allocated in the edge RBs or the outer carrier of a TDD band. For instance, consider three sub-bands in a TDD conventional band in which sub-band #1 or sub-band #3 can be allocated as UL sub-band in DL slots as shown in FIG. 4 and FIG. 5 respectively. Similarly, in option 2, it is also possible to consider only two sub-bands in a TDD band. For instance, sub-band #1 or sub-band #2 can be allocated as UL sub-band in DL slots/symbols starting from DL slot/symbol n+1 as shown in FIG. 6 and FIG. 7. The advantage of option 2 is that it can allow gNB to flexibly define the number of sub-bands, i.e., either two or three. In addition, in option 2, only one guard band is needed to separate the UL sub-bands from DL sub-bands, and thus it can efficiently utilize the frequency resources.

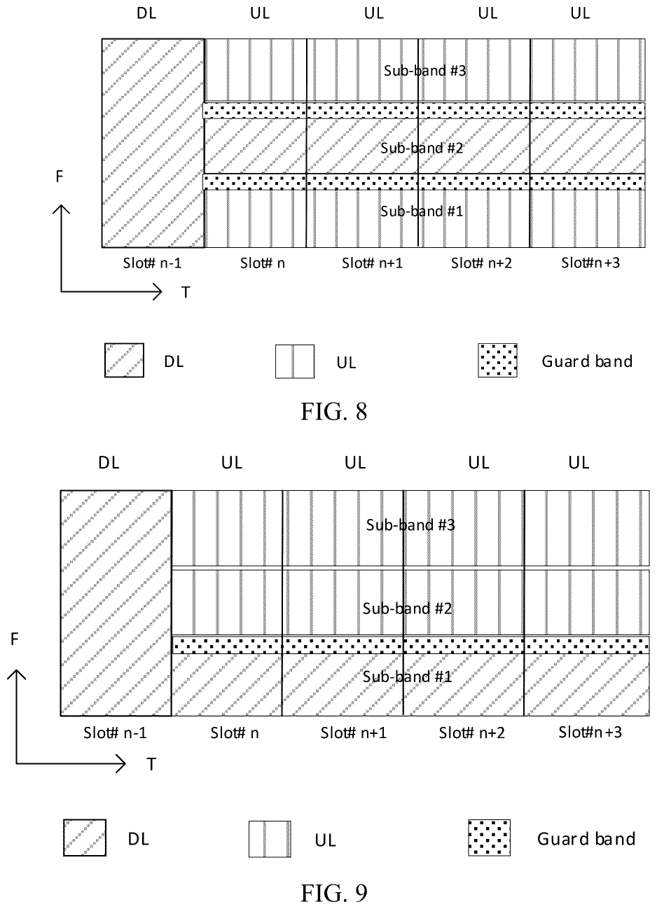

Some embodiments of the present disclosure discuss the time/frequency location of DL sub-bands in UL or flexible slots/symbols as explained in the above embodiments. For time location of DL sub-band in UL slots, some embodiments of this disclosure propose to allocate DL sub-bands in UL slots/symbols starting from the nth UL slot as shown in FIG. 8. For the frequency location of a sub-band in a conventional TDD band, there are two options similar to the above embodiments as given below.

Option 1: The frequency location of DL sub-band in UL slots/symbols can be allocated in the inner part of carriers or the inner RBs between the two UL sub-bands. For instance, consider three sub-bands in a TDD conventional band in which sub-band #2 can be used as DL sub-band in between sub-band #1 and sub-band #3 as shown in FIG. 8.

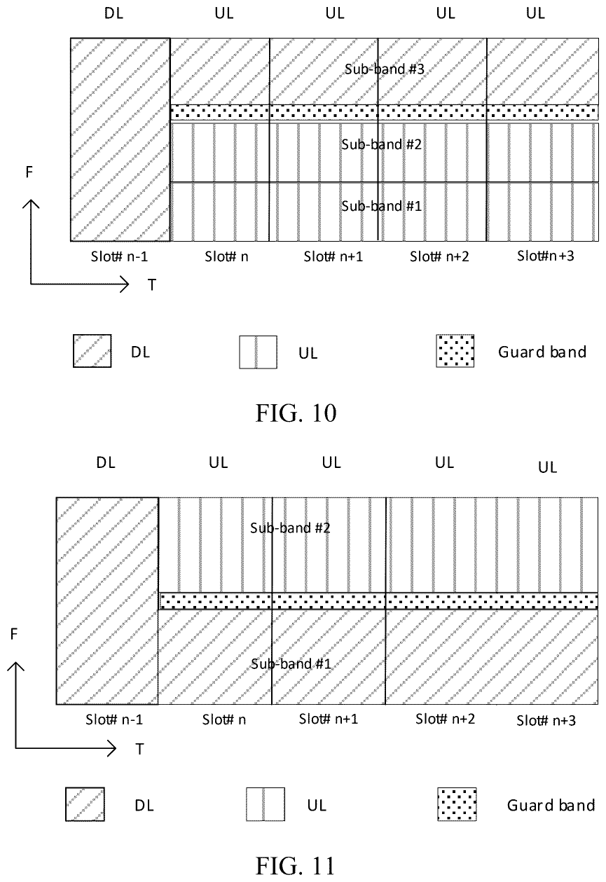

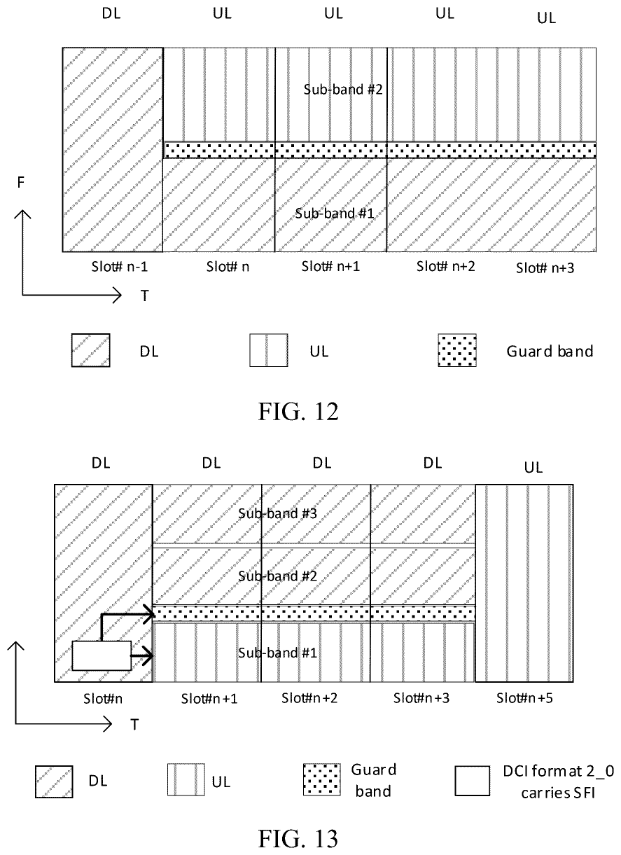

Option 2: The frequency location of DL sub-band in UL slots/symbols can be allocated in the edge RBs or outer carrier of a TDD band. For instance, consider three sub-bands in a TDD conventional band in which sub-band #1 or sub-band #3 can be allocated as DL sub-band in UL slots/symbols as shown in FIG. 9 and FIG. 10 respectively. Similarly, in option 2, it is also possible to consider only two sub-bands in a TDD band, where sub-band #1 or sub-band #2 can be allocated as DL sub-band in UL slots/symbols starting from UL slot n as shown in FIG. 11 and FIG. 12 respectively.

Some embodiments of the present disclosure discuss semi-static and dynamic configuration/indication of a sub-band to the UE, for simultaneous UL and DL transmission at gNB side and half duplex operation at UE side.

In semi-static configuration, RRC signaling can be used to configure the UL sub-bands in DL slots or DL sub-bands in UL slots. Some embodiments of this disclosure define explicit configuration IEs for UL sub-bands in DL slots/symbols or DL sub-band in UL slots/symbols. In addition, the IEs defined for sub-bands can be included in the existing TDD-UL-DL configuration IE of the current specification such as TDD-UL-DL-ConfigCommon or TDD-UL-DL-ConfigDedicated, where the TDD-UL-DL-ConfigCommon determines the cell specific UL/DL TDD configuration and the TDD-UL-DL-ConfigDedicated determines the UE-specific UL/DL TDD configuration.

The IE for UL sub-band in DL slots/symbols are given below, where explicit configuration of SCS, the DL slots/symbols, where the frequency resources of UL sub-bands can be allocated in DL slots/symbols, the RBs of guard band, and the number and starting of UL RBs are indicated.

Subband-UL-Pattern::= SEQUENCE {

| | |
|---|---|
| SubCarrierSpacing | SubCarrierSpacing |
| nrofSubbandDownlinkSlots | INTEGER (0..maxNrofSlots), |
| startingOfSubbandDownlinkSlots | INTEGER (n+1..maxNrofSlots), |

| | |
|---|---|
| nrofDownlinkSymbols | INTEGER (0..maxNrofSymbols-1), |
| guardBand | INTEGER (0..maxNrofPhysicalResourceBlocks-1), |
| startingOfUplinkRB | INTEGER (0..maxNrofPhysicalResourceBlocks-1), |
| nrOfUplinkRBs | INTEGER (1..nrOfmaxNrofPhysicalResourceBlocks), |

},

The description of UL sub-band in DL slots/symbols semi-static configuration IE is given Table 1.

TABLE 1
UL-Subband FrequencyOccupation field descriptions

Subband-UL-Pattern
Sub-band uplink pattern define the frequency resources of uplink sub-band in downlink slots.
SubcarrierSpacing
Same SCS can be used which is used for the conventional TDD band in which sub-bands are configured, to determine
the time domain boundaries in the UL-DL pattern. The values 15, 30 or 60 kHz (FR1), and 60 or 120 kHz (FR2) are
applicable.
nrOfSubbandDownlinkSlots
Number of consecutive DL slots in which the PRB of UL subband are configured
StartingOfSubbandDownlinkSlots
Time domain slot where the uplink sub-band can be allocated in the downlink slots starting from (n+1)th slot
nrofDownlinkSymbols
Number of consecutive DL symbols in the slot, in which PRB of UL subband are configured
Guardband
PRB-level guard band between UL and DL sub-bands
nrOfUplinkRBs
Number of PRBs across which the Uplink sub-bands spans. The smallest configurable number is 1 PRB or a set of
consecutive PRBs for the uplink transmission direction
StartingOfUplinkRB
PRB where the Uplink sub-band frequency resource starts in relation to common resource block #0 (CRB#0) on the
common resource block grid.

Similarly, the WE for DL sub-band in UL slots are given below, where explicit configuration of SCS, the UL slots/symbols where the frequency resources of DL sub-bands can be allocated in UL slots, the PRB of guard band, and the number and starting of DL RBs are indicated.

Subband-DL-Pattern::= SEQUENCE {

| | |
|---|---|
| SubCarrierSpacing | SubCarrierSpacing |
| nrofSubbandUplinkSlots | INTEGER (0..maxNrofSlots), |
| startingOfSubbandUplinkSlots | INTEGER (n..maxNrofslots), |

| | |
|---|---|
| nrofUplinkSymbols | INTEGER (0..maxNrofSymbols-1), |
| guardBand | INTEGER (0..maxNrofPhysicalResourceBlocks-1), |
| startingOfDownlinkRB | INTEGER (0..maxNrofPhysicalResourceBlocks-1), |
| nrOfDownlinkRBs | INTEGER (1..nrOfmaxNrofPhysicalResourceBlocks), |

},

The description of DL sub-band in UL slots/symbols semi-static configuration IE is given Table 2.

TABLE 2
DL-Subband FrequencyOccupation field descriptions

Subband-DL-Pattern
Sub-band uplink pattern define the frequency resources of downlink sub-band in uplink slots.
SubcarrierSpacing
Same SCS can be used which is used for the conventional TDD band in which sub-bands are configured, to determine
the time domain boundaries in the UL-DL pattern. The values 15, 30 or 60 kHz (FR1), and 60 or 120 kHz (FR2) are
applicable.
nrOfSubbandUplinkSlots
Number of consecutive UL slots in which the PRB of DL subband are configured
StartingOfSubbandUplinkSlots
Time domain slot where the DL sub-band can be allocated in the UL slots starting form nth slot
nrofDownlinkSymbols
Number of consecutive UL symbols in the slot, in which PRB of DL subband are configured
Guardband
PRB-level guard band between UL and DL sub-bands
nrOfDownlinkRBs
Number of PRBs across which the Downlink sub-bands spans. The smallest configurable number is 1 PRB or a set of
consecutive PRBs for the Downlink transmission.
StartingOfDownlinkRB
PRB where the Downlink sub-band frequency resource starts in relation to common resource block #0 (CRB#0) on the
common resource block grid.

For dynamic configuration/indication of SBFD, slot format indicator (SFI) of the current specification can be used which is carried by DCI format 2_0 with CRC scrambled by SFI-RNTI. However, the current SFI is used only for slot indication of UL or DL conventional TDD band. In order to make the current SFI capable of SBFD indication, this disclosure defines new fields to be included in the SFI. For instance, the SFI for UL sub-bands in DL slots can include the following fields comprising number of DL slots, number of DL symbols, starting of DL slot, starting of UL PRB, number of UL PRB, and guard band. Similarly, the SFI for DL sub-bands in UL slots can include the following fields comprising number of UL slots, number of UL symbols, starting of UL slot, starting of DL PRB, number of DL PRB, and guard band.

For dynamic indication of UL sub-band in DL slots/symbols, the SFI can be transmitted in the nth DL slot/symbols as shown in FIG. 13. For instance, the slot n, n+1 and n+2 is configured as DL slots, in order to consider the other slots an SFI can be transmitted in slot n as shown in the FIG. 13, which inform the UE about the sub-band.

Co-existence of SBFD capable UE and legacy UE: Some embodiments of the present disclosure discuss the co-existence of legacy UE, and SBFD capable UE in a cell, where the legacy UE is not capable of sub-band full duplex operation. Since the legacy UE and SBFD capable UE may exist in the same cell where the SBFD configuration can be used, therefore some embodiments of this disclosure consider the following approaches of handling both types of UEs.

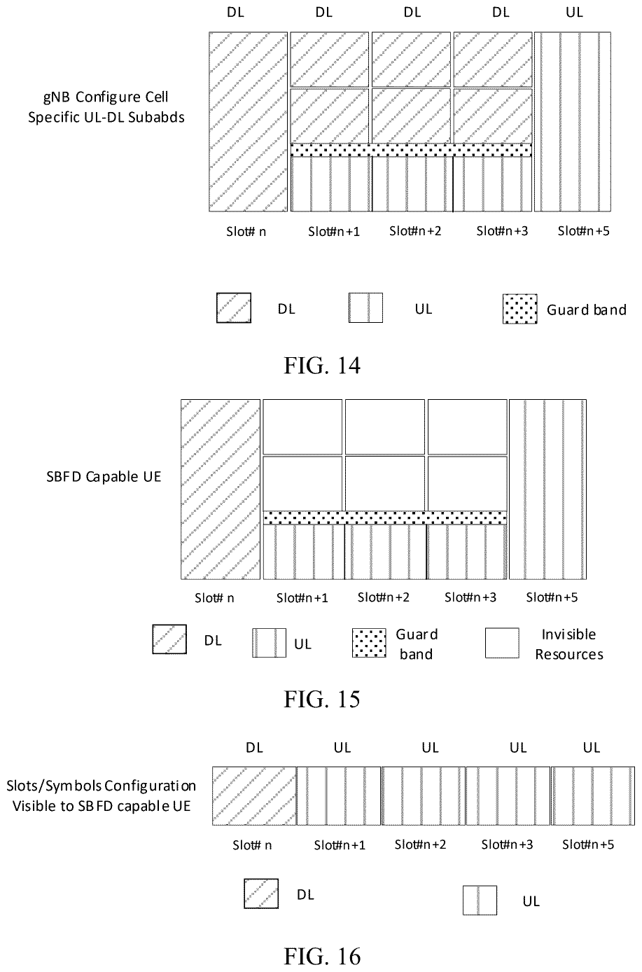

Configure/indicate SBFD configuration to the cell specific UEs via TDD-UL-DL ConfigCommon: In this approach, TDD-UL-DL-ConfigCommon of the current specification can be used to include the SBFD IE as explained in the above embodiments. Since TDD-UL-DL-ConfigCommon is cell specific configuration, and the cell may have both the legacy UE and SBFD capable UE. In this approach, some embodiments consider that SBFD IE in the TDD-UL-DL-ConfigCommon is not visible to the legacy UE and the legacy UE does not expect any opposite transmission direction e.g., UL, in the frequency resources which is assigned for DL transmission to the legacy UE. From gNB perspective, gNB may not use the DL sub-bands resources to perform UL operation for the legacy UE. In this approach the visibility of time/frequency resources to the gNB, legacy UE and SBFD capable UE are different from each other. For instance, the visibility of time/frequency resources to the gNB which are assigned to the legacy UE and SBFD capable UE are shown in FIG. 14. For the SBFD capable UE the UL sub-bands or frequency resources in the DL slots which are assigned in the TDD-UL-DL-ConfigCommon is visible to the SBFD capable UE as shown in FIG. 15. The visibility of the UL-DL slots to the SBFD capable UE is shown in FIG. 16.

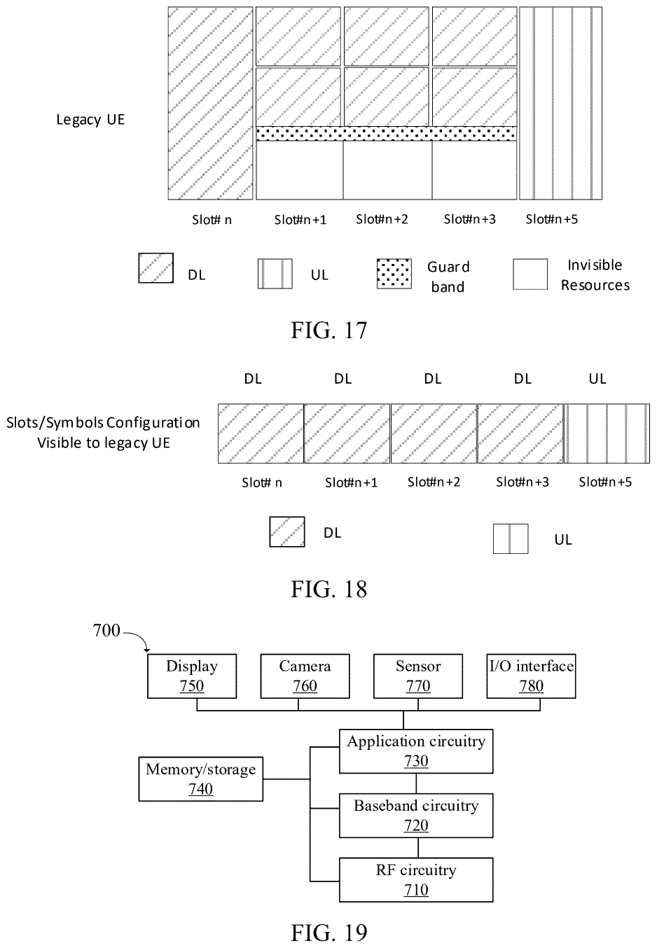

For the legacy UE, since legacy UE does not expect any UL configuration in the DL slots or DL configuration in UL slots. Therefore, the visibility of time/frequency resources or the RBs assigned for DL operation to the legacy UE is shown in FIG. 17. The slot visibility to the legacy UE is shown in FIG. 18.

Configure/indicate legacy UE via TDD-UL-DL-ConfigCommon, and SBFD capable UE via TDD-UL-DL-ConfigDedicated: In this approach, TDD-UL-DL-ConfigCommon of the current specification can be left as it is, and it can be used to configure legacy UEs. For SBFD capable UEs, TDD-UL-DL-ConfigDedicated can be used to configure the SBFD configuration. Since, TDD-UL-DL-ConfigDedicated is UE specific configuration, so it can easily override the UL sub-bands configuration in DL slots or the DL sub-bands configuration in UL slots to the group of SBFD capable UE.

Configure/indicate legacy UE through TDD-UL-DL-ConfigCommon and SBFD capable UE via dynamic SFI: In this approach, TDD-UL-DL-ConfigCommon of the current specification can be left as it is, and it can be used to configure legacy UEs. For SBFD capable UEs, SBFD capable UE can be configured/Indicated through dynamic SFI as explained in the above embodiments. In this approach since TDD-UL-DL-ConfigCommon may configure the legacy TDD-UL-DL configuration to all the UEs in the Cell. For SBFD capable UE, SFI can be used to dynamically indicate the sub-bands frequency resources to the SBFD capable UE.

Configure/indicate legacy UE through TDD-UL-DL-ConfigDedicated and SBFD capable UE via dynamic SFI: In this approach, TDD-UL-DL-ConfigDedicated of the current specification (without including the SBFD configuration) can be used to configure the UL-DL slots indication to a group of legacy UEs. For SBFD capable UE, SFI can be used to dynamically indicate the sub-bands time/frequency resources to the SBFD capable UE with the including the fields as discussed in the above embodiments.

In summary, some embodiments of the present disclosure propose several configurable parameters of sub-bands and have the following advantages: 1. Some embodiments of the present disclosure support full duplex operation (i.e., simultaneous UL/DL transmission) at gNB side to enhance the UL coverage, reduce the transmission latency, and increase the system capacity. 2. The proposed solutions present configurable parameters of sub-band to fully utilize the flexibility of sub-band full duplex operation and define sub-bands according to the UL/DL traffic requirements. 3. The proposed solutions consider the co-existence of legacy UE and SBFD capable UE in order to improve the backward compatibility.

FIG. 19 is a block diagram of an example system 700 for wireless communication according to an embodiment of the present disclosure. Embodiments described herein may be implemented into the system using any suitably configured hardware and/or software. FIG. 19 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated. The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A method for sub-band full duplex (SBFD) operation performed by a base station, comprising:
performing, by the base station, an SBFD operation using a configuration of the SBFD operation or an indication to a user equipment (UE), wherein the configuration of the SBFD operation comprises an uplink (UL) sub-band in downlink (DL), flexible slots/symbols or DL sub-band in UL, or flexible slots/symbols along with UL/DL sub-band configurable parameters, wherein the UL/DL sub-band configurable parameters comprise an allocation of time/frequency resources to UL/DL sub-bands and/or sub-band features of the UL/DL sub-bands.

2. The method according to claim 1, wherein an allocation of time resources of the UL sub-band in the UL/DL sub-band comprises a starting of a DL slot, a number of consecutive DL slots, a starting of DL symbols within a slot, and a number of consecutive DL symbols within the DL slots: or
wherein the DL sub-band within a UL slot comprises a starting of the UL slot, a number of consecutive UL slots, a starting of the UL symbols within a slot, and a number of consecutive UL symbols within the UL slots.

3. The method according to claim 2, wherein the sub-band features comprise a granularity of a sub-band, a bandwidth of the sub-band, and/or a number of sub-bands in a time division duplex (TDD) band.

4. The method according to claim 3, wherein the granularity of a sub-band is a resource block (RB) based granularity.

5. The method according to claim 4, wherein a number of RBs for the sub-band depends on a sub-carrier spacing of different numerology, and/or the number of RBs for the sub-band is configurable, which is adjusted according to bandwidth requirements of the sub-band.

6. The method according to claim 3, wherein the bandwidth of the sub-band is a configurable bandwidth of the sub-band, and the function to calculate the bandwidth of sub-band depend on: the new radio (NR) TDD band channel bandwidth in which the sub-bands are configured, the number of guard bands, the bandwidth of the guard bands defined for the sub-bands, and the total number of the sub-bands in conventional TDD bands in range of {2, 3, 4}.

7. The method according to claim 3, wherein in the number of the sub-bands in the TDD band, a minimum number of the sub-bands in the TDD band is 2, and/or a maximum number of the sub-bands in the TDD band is 3 or 4.

8. The method according to claim 2, wherein the allocation of the time/frequency resources to the UL/DL sub-bands comprises a time/frequency location of UL sub-bands in DL slots/symbols and/or a time/frequency location of DL sub-bands in UL slots/symbols.

9. (canceled)

10. The method according to claim 8, wherein a frequency location of an UL sub-band in the DL slots/symbols is allocated in an inner part of carriers or inner RBs between two DL sub-bands.

11. The method according to claim 8, wherein a frequency location of an UL sub-band in the DL slots/symbols is allocated in edge RBs or an outer carrier of the TDD band.

12. The method according to claim 2, wherein for a time location of a DL sub-band in UL slots, DL sub-bands are allocated in the UL slots/symbols starting from a nth UL slot.

13. The method according to claim 12, wherein a frequency location of the DL sub-band in the UL slots/symbols is allocated in an inner part of carriers or inner RBs between two UL sub-bands.

14. The method according to claim 12, wherein a frequency location of the DL sub-band in the UL slots/symbols is allocated edge RBs or an outer carrier of the TDD band.

15. The method according to claim 1, wherein the SBFD configuration and indication to the UE comprises a semi-static and/or dynamic configuration/indication of the sub-band to the UE, for simultaneous UL and DL transmission at the base station and half duplex operation at the UE.

16. The method according to claim 15, wherein for a semi-static configuration/indication of the SBFD operation, a semi-static configuration RRC signaling is used to configure the UL sub-bands in TDD DL slots/symbols or DL sub-bands in TDD UL slots/symbols.

17. The method according to claim 16, wherein the semi-static configuration RRC signaling comprises TDD-UL-DL-ConfigCommon or TDD-UL-DL-ConfigDedicated, where the TDD-UL-DL-ConfigCommon determines a cell specific UL/DL TDD configuration, and the TDD-UL-DL-ConfigDedicated determines a UE-specific UL/DL TDD configuration.

18. The method according to claim 16, wherein information elements (IEs) for the UL sub-band in the DL slots/symbols are used to indicate an explicit configuration of SCS, the DL slots/symbols where the frequency resources of UL sub-bands are allocated in the DL slots/symbols, the RBs of the guard band, and/or the number and starting of UL RBs.

19. The method according to claim 16, wherein information elements (IEs) for the DL sub-band in the UL slots/symbols are used to indicate an explicit configuration of SCS, the UL slots/symbols where the frequency resources of DL sub-bands are allocated in the UL slots/symbols, the RBs of the guard band, and/or the number and starting of DL RBs.

20-27. (canceled)

28. Abase station, comprising:
a memory;
a transceiver; and
a processor coupled to the memory and the transceiver;
wherein the processor is configured to execute a method for sub-band full duplex (SBFD) operation comprising:
performing an SBFD operation using a configuration of the SBFD operation or an indication to a user equipment (UE), wherein the configuration of the SBFD operation comprises an uplink (UL) sub-band in downlink (DL), flexible slots/symbols or DL sub-band in UL, or flexible slots/symbols along with UL/DL sub-band configurable parameters, wherein the UL/DL sub-band configurable parameters comprise an allocation of time/frequency resources to UL/DL sub-bands and/or sub-band features of the UL/DL sub-bands.

29-33. (canceled)

34. The base station according to claim 28, wherein an allocation of time resources of the UL sub-band in the UL/DL sub-band comprises a starting of a DL slot, a number of consecutive DL slots, a starting of DL symbols within a slot, and a number of consecutive DL symbols within the DL slots; or
wherein the DL sub-band within a UL slot comprises a starting of the UL slot, a number of consecutive UL slots, a starting of the UL symbols within a slot, and a number of consecutive UL symbols within the UL slots.
